(19) United States
(12) Patent Application Publication
(10) Pub. No.: US 2003/0228418 A1
(43) Pub. Date: Dec. 11, 2003

(54) Replication of nanoperiodic surface structures

(76) Inventors: Melissa A. Hines, Ithaca, NY (US); Christopher K. Ober, Ithaca, NY (US); Stephen L. Sass, Ithaca, NY (US)

Correspondence Address: William A. Blake, Jones, Tullar & Cooper, P.C., Eads Station, P.O. Box 2266, Arlington, VA, 22202, US

(21) Appl. No.: 10/382,473

(22) Filed: Mar. 6, 2003

Related U.S. Application Data
(60) Provisional application No. 60/362,330, filed on Mar. 8, 2002.

(51) Int. Cl. B05D 5/00

(52) U.S. Cl. 427/256

(57) ABSTRACT

A replication technique is employed to reproduce substrates having periodic nanometer scale structures formed on a surface thereof. In the technique, a thin film of cellulose acetate is placed on top of a template substrate having the desired surface to be replicated. The cellulose acetate is softened, thereby taking on the configuration of the template surface. The film is peeled off, yielding a negative replica of the template surface on the underside of the film. A thin layer of suitable material, such as gold, platinum, iron or carbon, is then deposited on the underside of the film, thus resulting in formation of a replica substrate having the same periodic nanostructure characteristics as the original template.

### CROSS REFERENCE TO RELATED APPLICATIONS

This application claims priority, under 35 USC 119(e), on U.S. Provisional Application No. 60/362,330, filed Mar. 8, 2002, which is hereby incorporated by reference.

### BACKGROUND OF THE INVENTION

1. Field of the Invention

The present invention relates in general to a replication technique for forming nanometer scale structures on a surface of a substrate.

2. Description of the Background Art

As the demand for smaller and smaller biological analysis apparatus, electronic devices, magnetic recording media, etc., has increased, a need has been created for improved fabrication processes for making such devices. Many such devices employ substrates that have two-dimensional patterns of periodic surface structures that are used for the subsequent formation of the devices, separation of biological samples, etc. The reduced size demands require that the spacing between the periodic structures be on the order of less than 100 nm.

Unfortunately, most previously known techniques for forming nanometer-scale patterns are not commercially feasible. For example, a number of lithographic methods exist that can be used to form these types of patterned structures. These methods include creating patterns in polymers, called resists, and using microlithography based on short wavelength UV radiation or electron beams. Patterns can be formed because the solubility of polymers is changed by the imaging radiation and, when exposed to a solvent, a portion of the polymer film is removed quickly to create the image. However, producing dimensions on a length-scale of less than 100 nm using these techniques is difficult and can be carried out only using very special imaging tools and materials.

The tremendous success of scanning probe microscopes has opened the way for the development of another fabrication technique known as proximal probe lithography. Very briefly, proximal probe lithography involves the use of a scanning tunneling microscope (STM) or an atomic force microscope (AFM). The techniques range from using the STM to define a pattern in a medium which is subsequently replicated in the underlying material, to STM induced materials deposition, and STM and AFM manipulation of nanometer scale structures. However, there is a significant amount of instrumental evolution that needs to take place before these proximal probe techniques can be practical in a high throughput environment.

A technique aimed at addressing the aforementioned shortcomings of known lithographic techniques is disclosed in U.S. Pat. No. 6,329,070, which issued on Dec. 11, 2001 to Stephen L. Sass et al. and is entitled “Fabrication Of Periodic Surface Structures With Nanometer-Scale Spacings.” In this technique, twist grain boundaries are introduced within a silicon bicrystal, which contains a two dimensionally periodic array of screw dislocations at its internal interface. The periodic interfacial structure is exposed by selective etching of the dislocation cores, thereby leaving a periodic array of nanometer-scale protrusions that can be referred to as nanobumps. The spacing, d, of the nanobumps is controlled by the choice of twist misorientation angle, θ, through Frank's rule, d=|b|/2 sin(θ/2), where b is the Burgers vector of the screw dislocation. Experiments using this technique demonstrated the formation of a periodic array of nanobumps with spacing of 38 nm and heights of 3 to 5 nm. This technique has the potential to produce periodic surface structures with spacings from 50 nm down to 2 nm. There is interest in producing such periodic surface structures in a wide variety of materials. In principle, this approach can be used in any material in which bicrystals can be obtained by the diffusion bonding of thin single crystals, produced, for example, by epitaxial growth or by using readily available thin single crystal wafers, as in the case of silicon. Although this technique works well, the production and etching of the bicrystals is time consuming.

### SUMMARY OF THE INVENTION

The present invention is directed to a replication technique that can be employed to reproduce nanoscale structures that have been formed on substrates using other known techniques, particularly the twist grain boundary technique set forth in the aforementioned '070 patent. The replication technique avoids the time consuming process of producing and then etching bicrystals, except for formation of the first substrate. Additional substrates are formed by using the first substrate as a template or pattern.

In the technique, a thin film of material that is capable of softening and conforming to the contour of an underlying surface is deposited on a top surface of a template substrate that has spaced nanobumps formed thereon in accordance with the technique set forth in the '070 patent. In the preferred embodiment, the film is formed of cellulose acetate and a drop of softening agent, such as acetone, is placed on the top surface of the template substrate before the film is deposited thereon. The acetone causes the cellulose acetate film to soften and take on the configuration of the underlying surface. After the acetone is allowed to evaporate, the film is peeled off, yielding a negative replica of the template surface on the underside of the film.

The underside of the replica film is then used as a template for the deposition of a thin layer of any desired material by a variety of known deposition techniques to make a replica substrate having a top surface which, like the original template, has a two-dimensional array of nanometer-scale spaced bumps formed thereon. More particularly, the cellulose acetate replica can be coated with a thin layer of any material, such as gold, platinum, carbon or iron, which can be deposited by evaporation, sputtering or electron beam techniques. In addition, the replica material can be selected to be virtually any material that can be softened to conform to the surface of the original template. For example, silicon rubber can be employed in order to give the resultant replica different mechanical properties. The silicon rubber replicas can then be used in an alternative technique as a rubber stamp to transfer the nanoperiodic structures to other surfaces by a stamping or printing process.

### BRIEF DESCRIPTION OF THE DRAWINGS

The features and advantages of the invention will become apparent from the following detailed description of a preferred embodiment thereof, taken in conjunction with the accompanying drawings, in which:

FIGS. 1-4 are schematic illustrations showing the steps carried out in the preferred embodiment of the present invention to form negative replicas of a surface structure having nanoscale periodic structures formed thereon with FIG. 1 showing a nanoperiodic structure template substrate; FIG. 2 showing a replica film deposited on the template of FIG. 1; FIG. 3 showing the resulting replica film peeled off of the template and inverted; and, FIG. 4 showing a thin layer of material deposited on the replica film of FIG. 3, thereby forming a substrate having nanometer scale periodic structures formed on a top surface thereof;

FIG. 5 is an AFM image of a template substrate used in an experiment with the present invention; and

FIG. 6 is an AFM image of a replica substrate formed in accordance with the preferred embodiment.

### DETAILED DESCRIPTION OF A PREFERRED EMBODIMENT

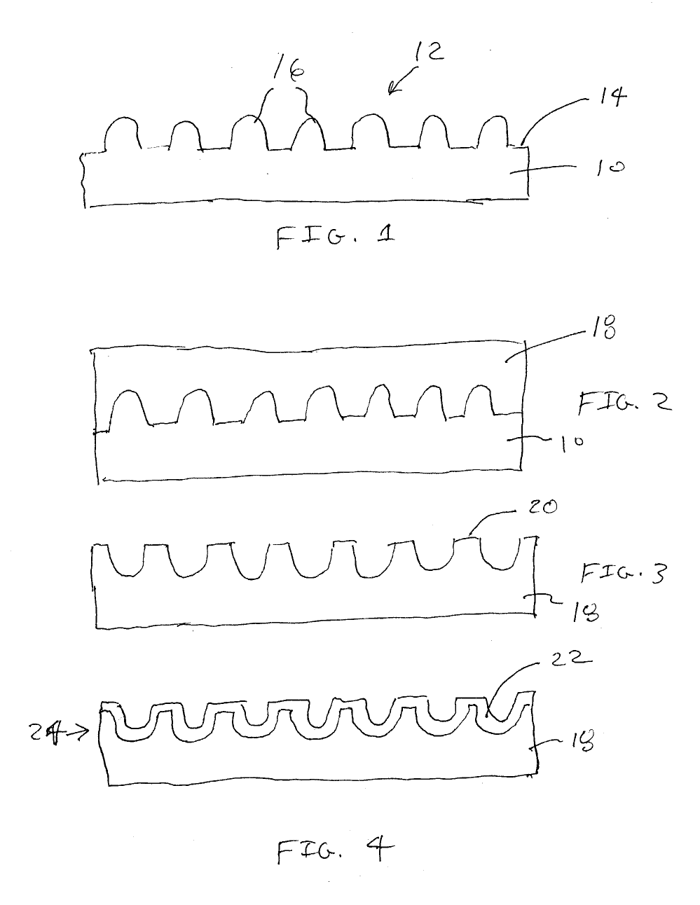

With reference to FIGS. 1-4, the steps carried out in the preferred embodiment of the replication technique are as follows. First, as shown in FIG. 1, a template substrate 10 is provided having a two-dimensionally periodic structure 12 formed on a top surface 14 thereof. The structure 12 is formed of a plurality of protrusions 16 referred to as nanobumps, each of which has a height of approximately 3-5 nanometers and is spaced from adjacent nanobumps by a distance of between 1.5 and 50 nanometers. Preferably, the template 10 is a silicon structure that has been formed using the twist grain boundary technique disclosed in the previously discussed U.S. Pat. No. 6,329,070, which is hereby incorporated by reference. An AFM image of such a structure is shown in FIG. 5. However, it will be understood that the template 10 could be formed of any other suitable material and by any technique that is capable of forming such structures.

Next, as illustrated in FIG. 2, a thin film 18 of cellulose acetate, such as the material sold under the trademark COLLODION, is placed on the top surface 14 of the template 10. In the preferred embodiment, a drop of softening agent, such as acetone or any other suitable solvent, is first placed on the top surface 14 of the template 10 prior to placement of the film 18 on the top surface 14. The acetone causes the cellulose acetate film 18 to soften and take on the configuration of the underlying surface. After sufficient time for the acetone to evaporate (typically 15 minutes), the acetate film 18 is peeled off, yielding a negative replica of the template top surface 14 on an underside 20 of the film 18 as illustrated in FIG. 3.

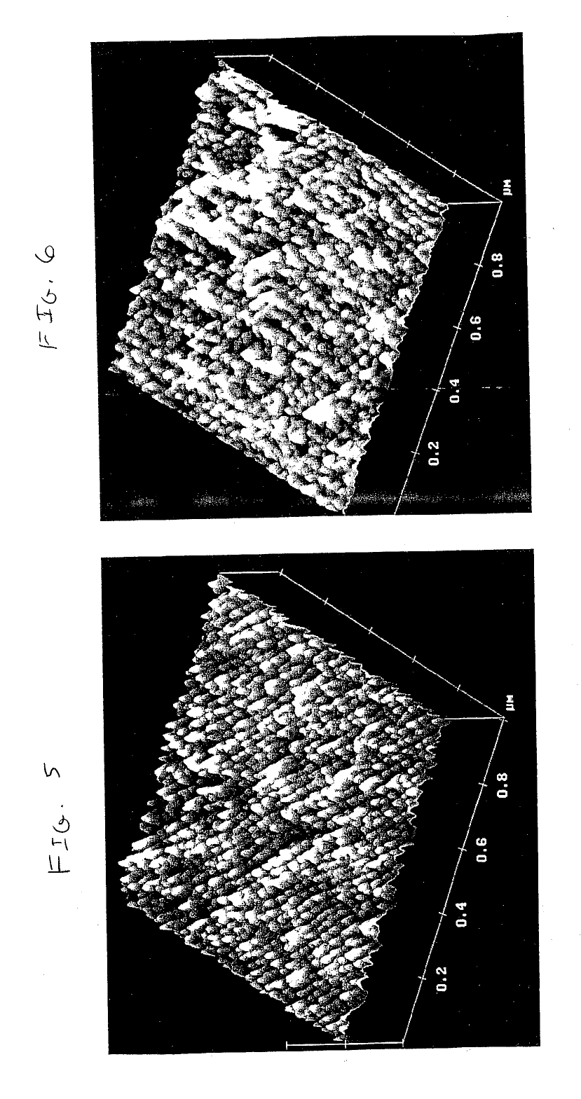

Finally, as illustrated in FIG. 4, the underside 20 of the film 18 is then used as the base for the subsequent deposition of a thin layer 22 of any desired material by any one of a variety of deposition techniques. This results in formation of a replica substrate 24 having the same two-dimensional nanoperiodic structure as the original template 10. Examples of suitable materials for the layer 22 include, but are not limited to, carbon, platinum, gold and iron. FIG. 6 is an AFM image of the substrate 24 resulting from an experiment in which the film 18 was coated with a carbon film with thickness of 15 nm. As compared to the original template of FIG. 5, it was found that the carbon replica clearly reproduces the periodicity of the original periodic surface structure. Since the negative copy in FIG. 6 looks similar to the top surface 14 of the original template 10, this suggests that a profile tracing the surface structure across the template surface must be sinusoidal in appearance. Experimental analysis of the template 10 before and after replication confirmed that the surface 14 had not been changed, thus indicating that the template 10 can be reused many times in the replication procedure.

The cellulose acetate replica can be coated with a thin film layer of any material, such as gold, platinum or iron, that can deposited by evaporation, sputtering or electron beam techniques. In addition, the replica material can be changed, for example, to silicon rubber, in order to give the resultant replica different mechanical properties. Silicon rubber replicas can then be used in an alternative process as a rubber stamp to transfer the nanoperiodic structures to other surfaces by a stamping or printing process.

Other replicas that have actually been formed in experiments with the present invention include a replica produced by depositing 5 nm of platinum on the cellulose acetate replica film. Comparing to the original template 10, it was found that, as in the case of the carbon replica, the Pt replica copies the surface structure faithfully. Another replica was produced by depositing 3 nm of gold on the cellulose acetate film. Comparing to the original template 10, it was found that the replica copies the surface structure, but has increased roughness relative to the original template. Finally, a fourth replica was produced by depositing 3 nm of a gold-palladium alloy on the cellulose acetate film. Comparing to the original template 10, it was once again found that the Au-Pd replica copies the surface structure faithfully.

The replicas, which are made from four different materials, demonstrate that it should be possible to produce surface structures containing periodic arrays of nanobumps from any substance that can be deposited on the cellulose acetate replica. The increased roughness of the Au replica as compared to those from carbon and Pt is likely related to enhanced surface diffusion of Au compared to the other materials (reference), which allows the grain size of the gold to increase, even at room temperature. Transmission electron microscopy shows, in fact, the Au film has a larger grain size (10-15 nm) than does the Pt film (1-2 nm). As the periodic spacing of the original Si template decreases, it may become more difficult to produce useful replicas from Au, due to the relatively coarse grained nature of a thin film of such a low melting point material. It remains to be seen what is the lower limit in spacing of the replication technique.

Although the invention as been disclosed in terms of a preferred embodiment and variations thereon, it will be understood that numerous additional modifications and variations could be made thereto without departing from the scope of the invention as defined by the following claims.

What is claimed is:

1. A method for replicating nanometer-scale two dimensionally periodic surface structures comprising the steps of:
a) providing a first substrate having a top surface with nanometer-scale two dimensionally periodic structures formed thereon,
b) applying a film to said top surface of said first substrate that is formed of a material that softens and conforms to said nanometer-scale two dimensionally periodic structures formed on said top surface;
c) removing said film from said first substrate, thereby exposing a negative replica of said top surface on an underside of said film; and
d) employing said negative replica on said underside of said film to form at least a second substrate having nanometer-scale two dimensionally periodic structures formed on a top surface thereof.

2. The method of claim 1, wherein the step of providing a first substrate further comprises forming said first substrate by the steps of:
1) providing first and second crystals, said second crystal having a thickness of between 5 and 100 nanometers;
2) bonding said first and second crystals together misoriented at an angle about a surface normal of said first and second crystals, thereby forming a twist boundary between said first and second crystals and producing periodic stress and strain fields that generate a buried nanometer-scale periodic structure extending into said second crystal; and
3) exposing said periodic structure to complete formation of said first substrate.

3. The method of claim 1, further comprising the step of applying a softening agent to said top surface of said first substrate prior to applying said film to said top surface.

4. The method of claim 3, wherein said softening agent is selected to be acetone.

5. The method of claim 4, wherein said film is selected to be cellulose acetate.

6. The method of clam 5, wherein said step of employing said negative replica on said underside of said film to form at least a second substrate having nanometer-scale two dimensionally periodic structures formed on a top surface thereof further comprises depositing a layer of material on said negative replica to form said second substrate.

7. The method of claim 6, wherein said layer of material is selected from the group comprising carbon, platinum, gold and iron.

8. The method of clam 1, wherein said step of employing said negative replica on said underside of said film to form at least a second substrate having nanometer-scale two dimensionally periodic structures formed on a top surface thereof further comprises depositing a layer of material on said negative replica to form said second substrate.

9. The method of claim 8, wherein said layer of material is selected from the group comprising carbon, platinum, gold and iron.

10. The method of claim 1, wherein said film is selected to be formed from rubber and said step of employing said negative replica on said underside of said film to form at least a second substrate having nanometer-scale two dimensionally periodic structures formed on a top surface thereof comprises stamping a top surface of said second substrate with said negative replicas on said underside of said rubber film.
